(19) United States
(12) Patent Application Publication
(10) Pub. No.: US 2025/0310997 A1
(43) Pub. Date: Oct. 2, 2025

(54) SHARING-BASED CHANNEL ACCESS PROCEDURE FOR NEXT GENERATION OF WIRELESS LAN

(71) Applicants: SONY GROUP CORPORATION, Tokyo (JP); SONY CORPORATION OF AMERICA, New York, NY (US)

(72) Inventors: Qing Xia, San Jose, CA (US); Salvatore Talarico, Los Gatos, CA (US)

(73) Assignees: SONY GROUP CORPORATION, Tokyo (JP); SONY CORPORATION OF AMERICA, New York, NY (US)

(21) Appl. No.: 19/085,452

(22) Filed: Mar. 20, 2025

Related U.S. Application Data
(60) Provisional application No. 63/572,427, filed on Apr. 1, 2024.

(51) Int. Cl. H04W 74/0816; H04W 74/08; H04W 84/12

(52) U.S. Cl. CPC H04W 74/0816; H04W 74/0875; H04W 84/12

(57) ABSTRACT

A channel access process to meet increasingly stringent low-latency WLAN requirements by mitigating channel access contention, through a cooperative TXOP sharing process between stations, while maintaining channel access flexibility for non-AP stations. When a non-AP STA obtains a Transmit Opportunity (TXOP) as ‘TXOP holder’, its TXOP can be shared in part with other non-AP STAs, as shared non-AP STAs; allowing the shared non-AP STAs to more efficiently transmit and utilize the channel during the shared TXOP without contending with each other for the channel. Simulations show the process provides significant mitigation of End-to-End (E2E) delay and allows improved spectrum utilization by reducing overall network congestion.

### CROSS-REFERENCE TO RELATED APPLICATIONS

This application claims priority to, and the benefit of, U.S. provisional patent application Ser. No. 63/572,427 filed on Apr. 1, 2024, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to wireless communications, and more particularly to the use of sharing-based channel access procedures in Wireless Local Area Networks (WLANS).

### 2. Background Discussion

Current wireless protocols generally require that centralized control be utilized in order to achieve ultra-low latency performance. However, in such centralized control, non-Access Point (non-AP) stations are subject to restricted operating flexibility, such as not being able to independently obtain a Transmit Opportunity (TXOP).

Accordingly, a need exists for a wireless protocol capable of supporting ultra-low latency operations, while non-AP stations still retain operating flexibility. The present disclosure fulfills that need and provides additional benefits over existing systems.

### BRIEF SUMMARY

A sharing-based channel access protocol is described toward reducing conflicting channel contentions, while still providing channel access flexibility for non-AP stations (STAs). In this sharing-based protocol, non-AP STAs cooperate with one another to reduce the number of channel contentions which arise. In particular, any non-AP STA which obtains channel access can elect sharing of its Transmission Opportunity (TXOP) with other stations, whether they are AP or non-AP stations. Upon receiving an allocation in the shared TXOP. these STAs can transmit within that allocation without the need for contending to obtain the channel.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station hardware, according to at least one embodiment of the present disclosure.

FIG. 2 is a block diagram of Multi-Link Device (MLD) hardware according to at least one embodiment of the present disclosure.

FIG. 3 is a flow diagram of transmit opportunity (TXOP) sharing according to at least one embodiment of the present disclosure.

FIG. 4A through FIG. 4C are frame transmission timelines compared between EDCA-based, trigger-based, and the disclosed sharing-based protocol, as compared with the sharing-based protocol according to at least one embodiment of the present disclosure.

FIG. 5 is a network topology diagram utilized for explaining the example embodiments, according to at least one embodiment of the present disclosure.

FIG. 6 is a probability graph that non-AP STAs within the coverage area of a reference BSS will be able to access the channel and transmit as a function of the distance across BSS, with the figure comparing trigger-based, EDCA-based, with the sharing-based protocol according to at least one embodiment of the present disclosure.

FIG. 7 is a probability graph that non-AP STAs within the coverage area of a reference BSS will be able to access the channel, with the figure comparing trigger-based, EDCA-based, with the sharing-based protocol according to at least one embodiment of the present disclosure.

FIG. 8 is an example network topology utilized in many of the examples according to at least one embodiment of the present disclosure.

FIG. 9 is a graph of Cumulative Distribution Function (CDF) of End-to-End (E2E) delay of the non-AP STAs in BSS1 comparing the traditional trigger-based protocol with the sharing-based protocol according to at least one embodiment of the present disclosure.

FIG. 10 are frame transmissions showing operational limitations of a trigger-based protocol.

FIG. 11 are frame transmissions showing End-to-End (E2E) delay for both the EDCA-based and the sharing-based protocols.

FIG. 12 is a graph of Cumulative Distribution Function (CDF) of E2E delay of the non-AP STAs in BSS1 comparing a trigger-based protocol with sharing-based protocol according to at least one embodiment of the present disclosure.

FIG. 13 is a graph of Cumulative Distribution Function (CDF) of the E2E delay of the non-AP STAs in BSS1 comparing an EDCA-based protocol with the sharing-based protocol according to at least one embodiment of the present disclosure.

### DETAILED DESCRIPTION

### 1. Introduction

Wi-Fi technology has been developing rapidly in recent years. Currently the latest Wi-Fi products in the market are using Wi-Fi 6 (E) technologies. From a standardization perspective, the IEEE working group for WLAN Standards is working toward finalizing the Wi-Fi 7 specification to provide an improved user experience for emerging cutting-edge applications, such as the metaverse, Augmented Reality (AR)/Virtual Reality (VR), robotics, industrial automation for industrial Internet-of-Things (IoT), logistics and smart agriculture. These applications offer a wide range of digitally enhanced worlds and business models that have the potential to revolutionize both personal and enterprise activities in the next decade and require Wi-Fi technology to support ultra-low latency operations, in which latency is less than 10 ms.

The End-to-End (E2E) delay of low latency sensitive traffic comprises several different components, including queuing delay, channel access delay, propagation delay, processing delay and re-transmission delay. The propagation delay is almost negligible because of the wireless travel at light speed of 3×10⁸ m/s in the air. The processing delay depends on the processor speed and design, which is highly application dependent. Accordingly, the present disclosure focuses mainly on reducing channel access delay, which is a principle contributor to E2E delay, while it also significantly impacts queuing delay and re-transmission delay.

There are major channel access protocols in Wi-Fi, including contention-based protocols, such as Enhanced Distributed Channel Access (EDCA)-based protocols, scheduling-based protocols, as well as trigger-based channel access protocols.

In traditional EDCA-based channel access protocols, each non-AP station (STA) senses the status of the wireless medium (e.g., busy or idle) and maintains a backoff (BO) timer. The BO timer starts counting down if the medium is idle and is paused otherwise. The non-AP STA initiates transmission in the medium when the BO timer counts down to zero. The EDCA based channel access protocol grants substantial flexibility to the non-AP STAs, by allowing them to contend for channel access at any time. However, when multiple non-AP STAs simultaneously transmit signals, collision can often occur, which leads to re-transmissions from these non-AP STAs, and thus, increases channel access contention delay and which negatively impacts the user experience.

Comparatively, in trigger-based channel access protocols, the Access Point (AP) operates as a centralized coordinator/scheduler, which first collects information, such as buffer status, from the associated non-AP STAs and then solicits Uplink (UL) transmissions through a basic trigger frame. The trigger-based channel access protocol reduces competitions from non-AP STAs due to the use of centralized scheduling. However, this advantage comes with decreased channel access flexibility for non-AP STAs.

In this context, the present disclosure describes a new sharing-based channel access protocol, which can effectively reduce channel contentions, while still maintaining channel access flexibility for non-AP STAs. In this sharing-based protocol, non-AP STAs cooperate with each other to reduce access contentions. More specifically, any non-AP STA which obtains channel access may share its Transmission Opportunity (TXOP) with others (including the AP). Any non-AP STA receiving permission to access this shared TXOP can transmit without contending for the channel.

### 2. Embodiment of STA and MLD Hardware

The present disclosure can be implemented on wireless hardware STAs and Multiple-Link Devices (MLDs), which are exemplified in the following.

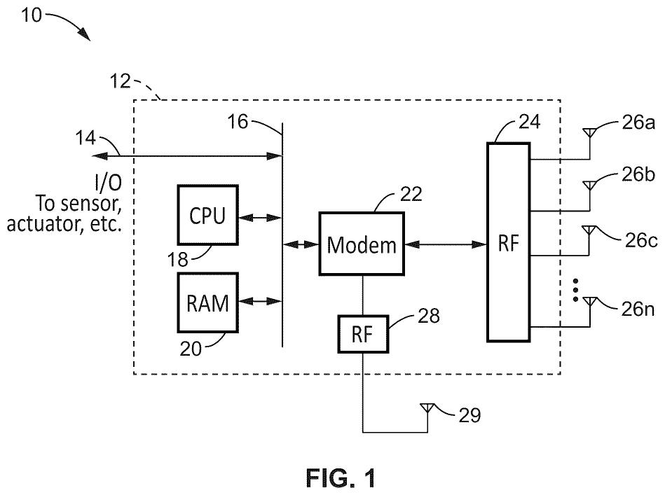

FIG. 1 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

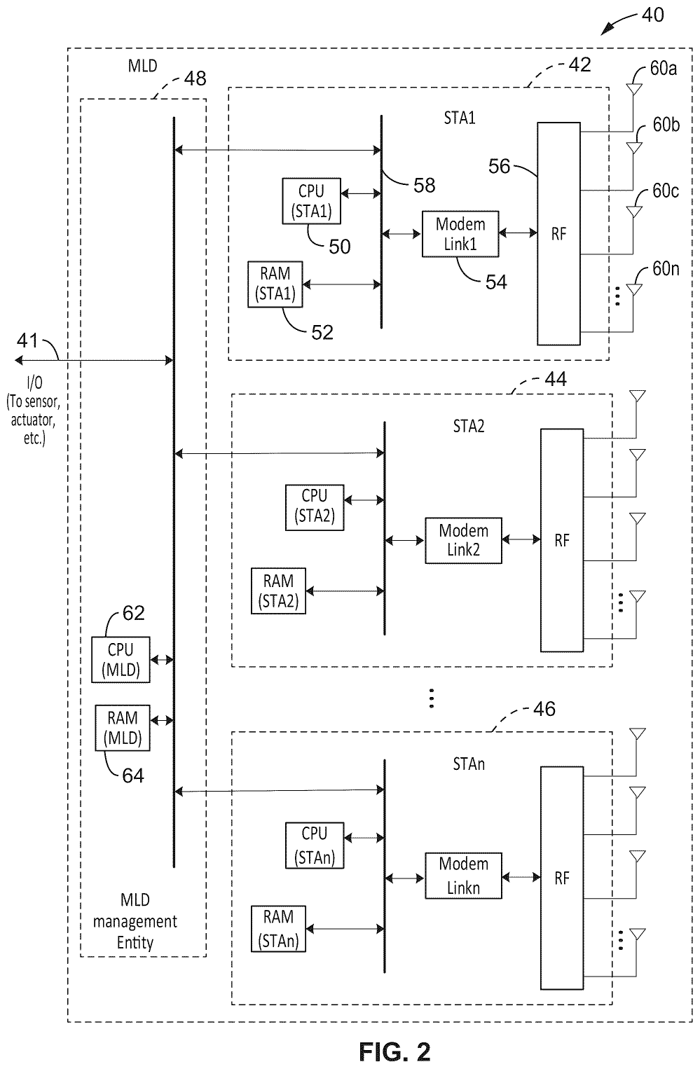

FIG. 2 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHZ), basic link set (2.4 GHz and 6 GHZ).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 3. Sharing-Based Protocol

In this section, a new sharing-based protocol is introduced and described, which is based on allowing a TXOP to be initiated and shared across non-Access Point (AP) Stations (STAs) in order to achieve a more optimal spectrum utilization. The new protocol is then compared with both the conventional Enhanced Distributed Channel Access (EDCA)-based protocol and trigger-based protocol which have already been adopted by the Wi-Fi 802.11 standard.

### 3.1 Protocol Description

A novel sharing-based protocol is designed to mitigate contention among non-AP STAs by allowing a level of cooperative TXOP sharing among them. In particular, the proposed protocol is based upon the logic that when a non-AP STA obtains a TXOP as the ‘TXOP holder’, its TXOP can be shared in part with other non-AP STAs, as shared non-AP STAs. In this way, the disclosed protocol allows the shared non-AP STAs to more efficiently transmit and utilize the channel during the shared TXOP without contending for the channel among them. Thus, the sharing-based protocol can reduce contention among non-AP STAs, while maintaining channel access flexibility from the point of view of the individual non-AP STAs, since these non-AP STAs are still allowed to contend independently for the channel once there is no active TXOP, when they either serve as TXOP holder or shared non-AP STA, which inherently improves End-to-End (E2E) latency performance.

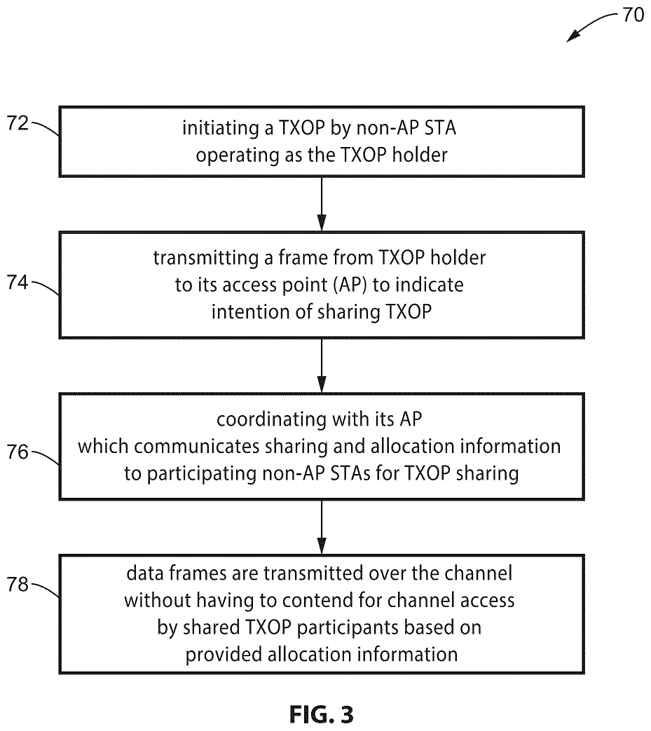

FIG. 3 illustrates an example embodiment 70 of transmit opportunity (TXOP) sharing toward mitigating contention among non-AP STAs in a cooperative TXOP sharing process. To initiate a shared TXOP 72 from the non-AP STA side, by the non-AP STA acting as TXOP holder. Then to send a frame 74, such as sending a Ready-To-Send (RTS) sharing frame, to the associated AP with indication of both its willingness of share the TXOP along with sharing information, such as the shared TXOP duration allocated to each of the shared non-AP STAs participating in the shared TXOP and the traffic priority requirements.

In this embodiment a special RTS and CTS frames, termed ‘RTSs’ and ‘CTSs’ are utilized which contain fields containing the information about sharing and allocations as well as responses regarding sharing and allocations. These shared frames for example, indicate the STA is willing to share its TXOP to others, the duration it wants to share and/or the preferred traffic priority of the shared STA. For example the AP sends CTS sharing frame to indicate the shared duration and/or the preferred traffic priority to the destinated STA.

At this point, the associated AP of the TXOP holder assists in coordinating 76 between the TXOP holder and the shared non-AP STAs participating in the shared TXOP.

In particular, after receiving the frame (e.g., Ready-To-Send (RTS) sharing frame) from the TXOP holder, the AP processes (e.g., loops through) the identified shared non-AP STAs participating in the shared TXOP by polling each of them through a receiving a frame (e.g., Clear-To-Send (CTS) sharing frame), which carries the sharing information as indicated from the RTSs frame. Upon receiving the frame (e.g., CTS sharing frame), the shared non-AP STAs polled by its associated AP can transmit Data frames 78 within the allocated shared TXOP duration of the shared TXOP, without the need to contend for channel access.

In particular, a non-AP STA within the participating non-AP STAs, may send a frame to the associated AP, indicating a rejection of TXOP sharing, if any of the following conditions applies: (a) the shared non-AP STA completes its transmission earlier than the assigned shared TXOP duration; (b) the non-AP STA is approaching an end point of the assigned shared TXOP duration; (c) the non-AP STA does not have any data to deliver.

From the perspective of the AP for the TXOP holder, it may either keep processing (e.g., polling) the shared non-AP STAs participating in the shared TXOP until it reaches the TXOP limitation, or poll only a set of the shared non-AP STAs and terminate the shared TXOP earlier than the TXOP limitation if it is no longer receiving any data from the shared non-AP STAs. In both cases, the AP of the TXOP holder will broadcast a CFend frame to clear the Network Allocation Vector (NAV) which prevented channel contentions during the shared TXOP.

3.2 Comparison with Existing Protocols

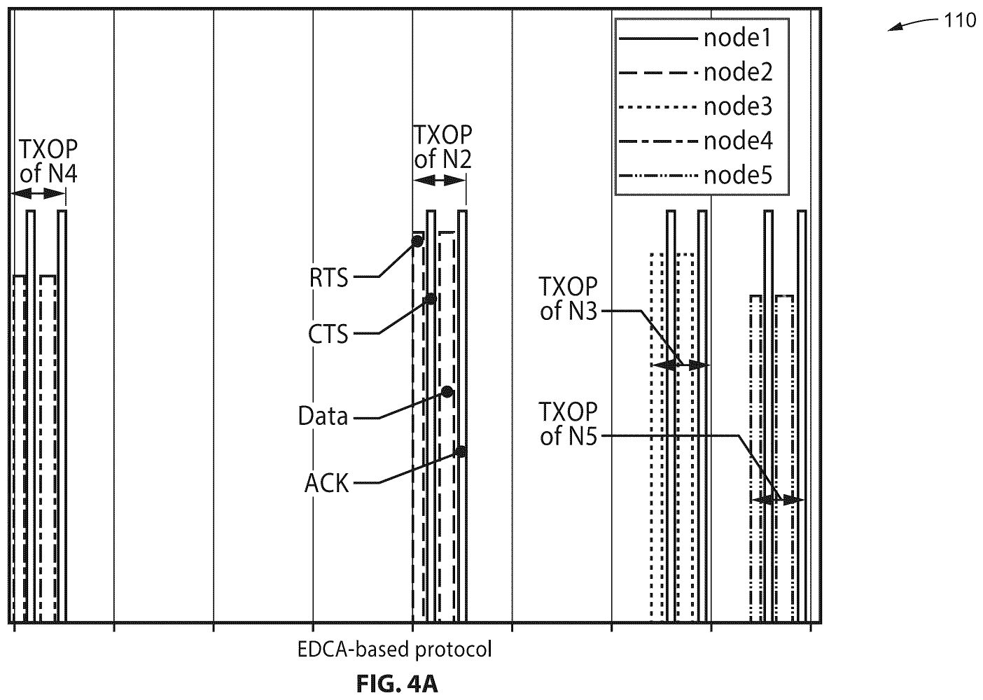

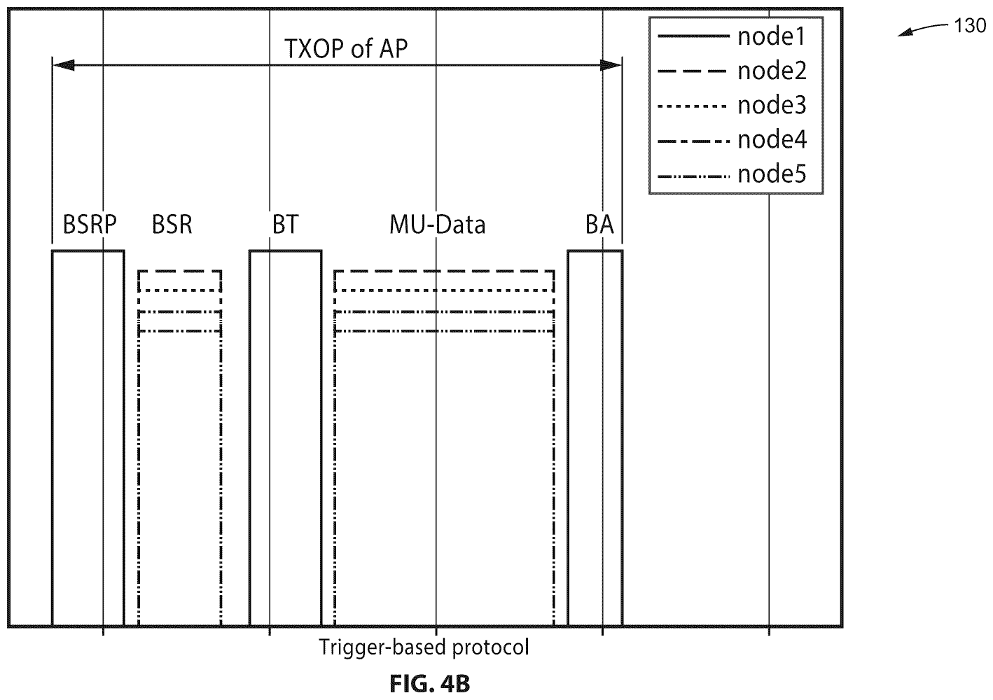

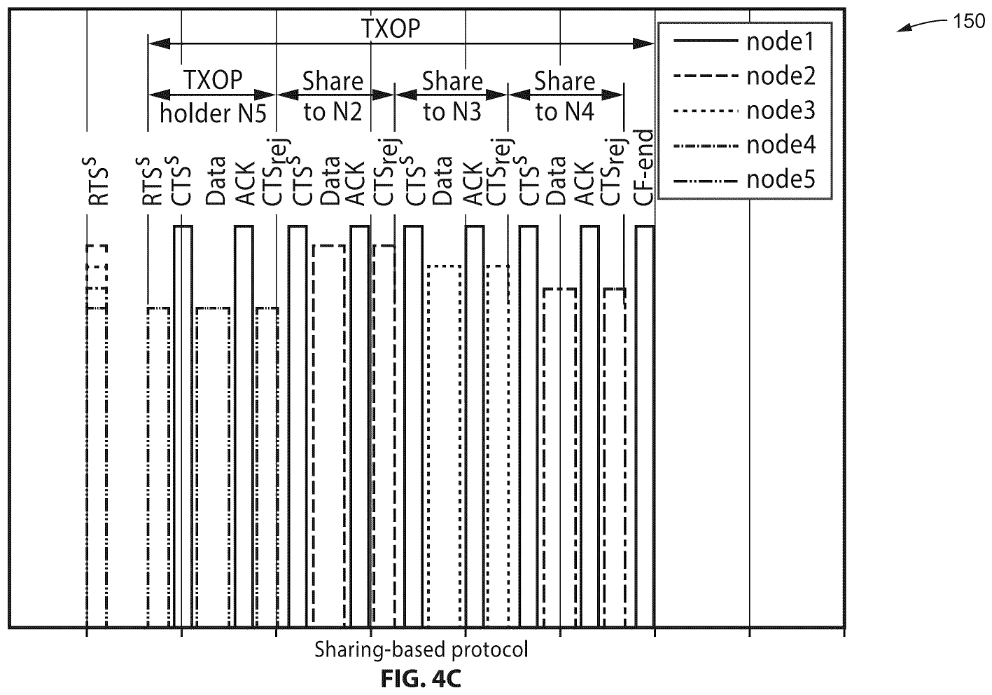

FIG. 4A through FIG. 4C depict a typical timeline of frame transmissions in the conventional EDCA-based (FIG. 4A 110), as well as trigger-based communication (FIG. 4B 130), in comparison with the disclosed sharing-based protocol (FIG. 4C 150). In each timeline, the frame transmissions are from 5 nodes, including one AP, which is denoted as node 1, and four associated non-AP STAs, which are marked as nodes 2-5, respectively.

In FIG. 4A is depicted 110 the timeline for the EDCA-based protocol, and each non-AP STA contends for the channel independently and there is no cooperation among them. The figure depicts TXOPs of station nodes 1 through 5.

In FIG. 4B is depicted 130 the timeline for the trigger-based protocol. In this case, the AP contends for channel access and once it has obtained the TXOP it sends the Buffer Status Report Poll (BSRP) frame to solicit Buffer Status Report (BSR) frames from the polled non-AP STAs. Then, based on the obtained BSR information, the AP transmits a Basic Trigger (BT) frame to trigger the Uplink (UL) Multi-User (MU)-Data frames from the triggered STAs. Lastly, the AP sends a Block Ack (BA) frame as a response to the reception of MU-Data. Communications here are also shown for station nodes 1-5.

Finally, in FIG. 4C is illustrated 150 a timeline for the sharing based protocol as described in Section 3.1, wherein for this example node 5 acts as a TXOP holder.

### 4. Statistical Channel Access Model

In this section, the EDCA-based, trigger-based and sharing-based protocol described in the prior section are compared by defining a statistical model, and in particular by formulating for each of the three protocols the probability that the non-AP STAs within the coverage range of a reference Basic Service Set (BSS) will be able to access the channel and transmit.

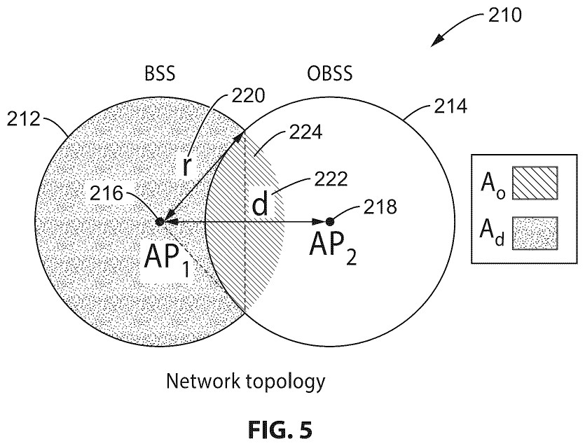

FIG. 5 illustrates an example 210 of a network composed of two adjacent BSSs 212, 214, one of which is the reference BSS where the intended transmissions occurs and the other is an Overlapping Basic Service Set (OBSS). AP1 216 and AP2 218 are shown. AP1 is shown with a coverage area (radius) r 220, with the ranges of AP1 and AP2 overlapping 224 by a distance d 222.

It should be appreciated that this example is provided toward describing a specific topology to simplify understanding of the operations involved, and not by way of limiting the wireless network to any specific topology and/or case. In this example it is assumed that all BSSs have the same coverage area as the corresponding APs and transmit with the same transmitting power.

Each BSS is modelled by a circular region with radius r where the corresponding AP is located in the center, and its coverage area is equal to A=πr². Each AP is associated with M non-AP STAs, which are distributed within the area A according to a Poisson Point Process (PPP) with intensity λ=M/A, where the probability that m non-AP STAs would be located in the coverage area A is

$${ℙ}_{A} [ m ] = \frac{{( λ A )}^{m}}{m !} {e}^{- λ A} . \qquad ( 1 )$$

In this example it is assumed that the reference BSS and the OBSS are located so that their coverage area would overlap and the respective APs would be distanced by d, where d∈[0,2r]. Let Aₒ denote the overlapped coverage area between the two BSSs. It is further assumed for this example that the power received by any non-AP STA located within distance Aₒ from the unintended AP is sufficient to prevent the non-AP STA from accessing the channel, as that transmission would cause interference, while an adjacent AP may not cause interference if the non-AP STA is located outside distance Aₒ, and let us define this area as A_{d}. Accordingly, the overlapped coverage area Aₒ is given by:

$${A}_{o} = 2 ( {r}^{2} {cos}^{- 1} ( \frac{d}{2 r} ) - \frac{d}{4} \sqrt{4 {r}^{2} - {d}^{2}} ) . \qquad ( 2 )$$

while A_{d}=A−Aₒ.

### 4.1 EDCA-Based Channel Access

In this example it is assumed that each non-AP STA associated with the reference BSS, is distributed within A_{d} according to a PPP with intensity λ_{A}, and considering that a new frame is generated at a rate given by λ_{A}_{_{d}}=1/(ατ), where a is a constant indicating the inverse of the activity rate, and τ is the frame duration. In this case, the aggregated rate generated by i non-AP STAs associated with the reference BSS, where all transmissions are orthogonal in the time domain, is λ′_{A}_{_{d}}=iλ_{A}_{_{d}}. In view of this the probability that n out of i devices are active during a vulnerable window of 2τ, meaning that n devices perform transmissions which overlap in the time domain across them and cause intra-BSS collisions with each other, is given by,

$${ℙ}_{{A}_{d}} [ n \vert 2 τ ] = \frac{{( 2 τ {λ}_{{A}_{d}}^{′} )}^{n}}{n !} {e}^{- 2 τ {λ}_{{A}_{d}}^{′}} \qquad ( 3 )$$

Then, the probability that a non-AP STA associated with the reference BSS experiences an intra-BSS collisions in A_{d} is

$$( 4 )$$

$${ℙ}_{{A}_{d}}^{fail} = {\sum }_{i = 1}^{∞} {ℙ}_{{A}_{d}} [ i ] ( 1 - {ℙ}_{{A}_{d}} [ n = 0 \vert 2 τ ] ) = {\sum }_{i = 1}^{∞} \frac{{( {λ}_{A} {A}_{d} )}^{i}}{i !} {e}^{- {λ}_{A} {A}_{d}} ( 1 - {e}^{- \frac{2 i}{α}} ) .$$

Conversely, if it is assumed that each of the non-AP STAs associated to the reference BSS or the OBSS, which are distributed within Aₒ according to a PPP with intensity λ_{A} and λ_{B}, respectively, generate a new frame at a rate given by λ_{A}_{ₒ}=1/βτ, where β is a constant indicating the inverse of the activity rate. In this case, the aggregated traffic generated by j non-AP STAs associated with the OBSS, where all transmissions are orthogonal in the time domain, is λ′_{A}_{ₒ}=jλ_{A}_{ₒ}. In view of the probability that n out of i+j devices are active during a vulnerable window of 2τ, means that n devices perform transmissions which overlap in the time domain across them and cause both inter and intra-BSS collisions to each other, as given by

$${ℙ}_{{A}_{d}} [ n \vert 2 τ ] = \frac{{( 2 τ {λ}_{{A}^{′}} )}^{n}}{n !} {e}^{- 2 τ {λ}_{{A}^{′}}} , where {λ}_{{A}^{′}} = {λ}_{{A}_{d}}^{′} + {λ}_{{A}_{o}}^{′} . \qquad ( 5 )$$

Then, the probability that a non-AP STA associated with the reference BSS experiences both intra and inter-BSS collisions in Aₒ is

$${ℙ}_{{A}_{d}}^{fail} = {\sum }_{i , j = 1}^{∞} {ℙ}_{{A}_{0}} [ i ] {ℙ}_{{A}_{0}} [ j ] ( 1 - {ℙ}_{{A}_{d}} [ n = 0 \vert 2 τ ] ) = {\sum }_{i , j = 1}^{∞} \frac{{( {λ}_{A} {A}_{0} )}^{i} {( {λ}_{B} {A}_{0} )}^{j}}{i ! j !} {e}^{- {A}_{0} {λ}^{′}} ( 1 - {e}^{- 2 ( \frac{i}{α} + \frac{j}{β} )} ) \qquad ( 6 )$$

$$where {λ}^{′} = {λ}_{A} + {λ}_{B} .$$

Finally, the probability that non-AP STAs within the coverage area of a reference BSS will be able to access the channel and transmit is given by:

$${ℙ}_{success} = 1 - ( \frac{{A}_{d}}{A} {ℙ}_{{A}_{d}}^{fail} + \frac{{A}_{0}}{A} {ℙ}_{{A}_{0}}^{fail} ) . \qquad ( 7 )$$

### 4.2 Trigger-Based Channel Access

For the trigger-based channel access model, the formula to calculate P_{success} is the same as that in Section 4.1, except for Eq. (3) and Eq. (5), where λ′_{A}_{_{d}}, is replaced with λ′_{A}_{_{d}}^{trigger} which is defined as follows

$${λ}_{{A}_{d}}^{trigger} = ( {λ}_{{A}_{d}}^{′} ( 1 - {λ}_{STA}^{triggered} ) + {λ}_{g}^{trigger} ) \qquad ( 8 )$$

where λ_{STA}^{triggered} is the set of triggered non-AP STAs, which transmit an uplink transmission upon receiving a trigger frame from the associated AP, thus they don't contend for the channel, and λ_{g}^{trigger}=1/(ωτ) represents the trigger frame generation rate from the associated AP, where ω is a constant value indicating the frequency of the trigger frame.

### 4.3 Sharing-Based Channel Access

For the sharing-based channel access model, the formula to calculate P_{success} is also the same as the equation in Section 4.1, except for Eq. (3) and Eq. (5), where λ′_{A}_{_{d}} is replaced with λ_{A}_{_{d}}^{shared} as defined as follows.

$${λ}_{{A}_{d}}^{share} = ( {λ}_{{A}_{d}}^{′} ( 1 - {λ}_{STA}^{shared} ) + {λ}_{{A}_{d}} ) . \qquad ( 9 )$$

where λ_{STA}^{shared} is the set of non-AP STAs participating in a shared TXOP, which could be considered as one group with the sharing feature. This indicates that as long as any sharing STA obtains the channel, the sharing group would also intrinsically obtain channel access.

### 4.4 Numerical Results

In order to compare the three protocols described in Section 3, τ=5 ms, τ=10 m, and A_{A}=A_{B}=0.1. Furthermore, in order to consider a scenario where the inferences from the OBSS are dominant, α=500 and β=1. Furthermore, to simulate a case where the trigger frame generation rate is higher than the general frame generation rate from the non-AP STA in the trigger-based scenario, ω=100.

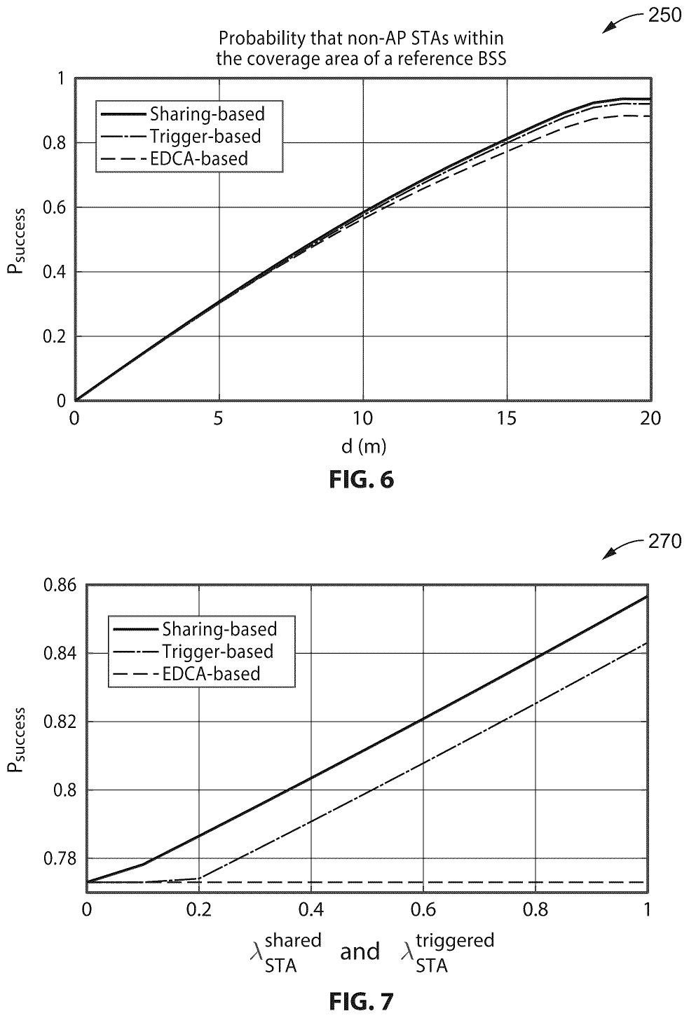

FIG. 6 illustrates 250 the probability that non-AP STAs within the coverage area of a reference BSS will be able to access the channel and transmit as a function of the distance across BSSs. This figure is obtained with λ_{STA}^{shared}=λ_{STA}^{triggered}=0.5, and highlights that the farther apart the adjacent BSSs are, the easier it is for non-AP STAs in the intended BSS to obtain channel access.

FIG. 7 illustrates 270 the probability that non-AP STAs within the coverage area of a reference BSS will be able to access the channel and transmit as a function of λ_{STA}^{shared} or λ_{STA}^{triggered}. These results were obtained with λ_{STA}^{shared}=λ_{STA}^{triggered} and d=15 m, and highlights that the more non-AP STAs join the shared TXOP, the easier it is for this group of non-AP STAS to access the channel.

It is also important to note that both FIG. 5 and FIG. 6 highlight the merit of the sharing-based channel access protocol over both the trigger-based and EDCA-based protocol, where of the three, the EDCA-based protocol provides the lowest level of performance.

### 5. Simulation Results

In this section, results obtained through comprehensive system level simulations are provided with the aim to evaluate the performance of the proposed protocol and compare it with the other two state-of-art protocols described in Section 3. The simulations are performed under the assumptions summarized in Table 1.

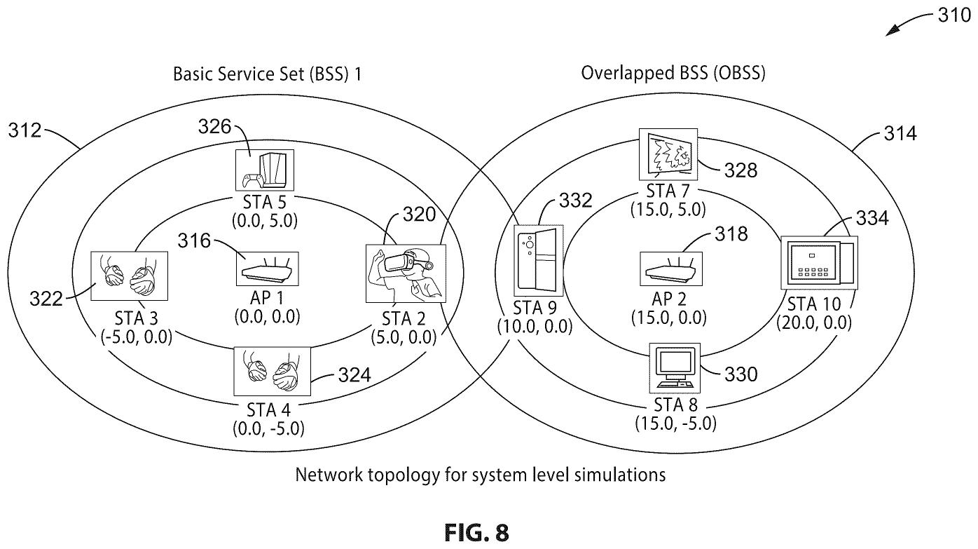

FIG. 8 illustrates an example network topology 310 utilized in these simulation results. This topology comprises two BSSs 312, 314, where one is the reference BSS, as BSS1 312, and the other is an OBSS, as BSS2 314. In BSS1, AP1 316 has four associated non-AP STAs STA2 320, STA3 322, STA4 324 and STA5 326, which are distributed in this example as 5 meters away from AP1 in both the horizontal and vertical direction. In OBSS 314, AP2 318 is located 15 meters away from AP1 316. AP2 318 also has four associated non-AP STAs as STA7 328, STA8 330, STA9 332 and STA10 334, these being distributed 5 meters away from AP2 in both the horizontal and vertical directions.

5.1 OBSS with Lower Priority Traffic

Using the aforementioned topology, one of the use cases considered is to study the effects from an OBSS when this is serving lower priority traffic. More specifically, in this case the traffic in each BSS is set as follows. (a) In BSS1, each non-AP STA generates one packet every 5 ms in a constant manner. In case of non trigger-based scenarios, the non-AP STAs contend for the channel with the maximum Access Category (AC) (i.e., AC3). While in the case of trigger-based scenarios, the non-AP STAs transmit UL packets after receiving the trigger frame from AP1, where AP1 sends the trigger frame every 5 ms. (b) In BSS2, each non-AP STA is in full buffer mode. AP2 and its associated non-AP STAs contend for the channel with the lowest AC (i.e., AC0). In this example different traffic conditions are simulated to increase the interference from the OBSS by increasing the number of non-AP STAs associated with OBSS, and the following scenarios are considered: (i) OBSS-Light (OBSS-L) in which only AP2 and STA7 are actively transmitting; (ii) OBSS-Medium (OBSS-M) in which only AP2, STA7 and STA8 are actively transmitting; and (iii) OBSS-Large (OBSS Large) in which AP2 and all four associated STAs are actively transmitting.

It should be noticed that in this case, as the OBSS has a lower priority class than that of the reference BSS, the contention from the OBSS AP and non-AP STAs have minor impact on system performance in terms of E2E delay for the non-AP STAs associated with the reference BSS; yet what is more relevant is the impact in terms of blockage caused by the existing transmission(s) from the OBSS.

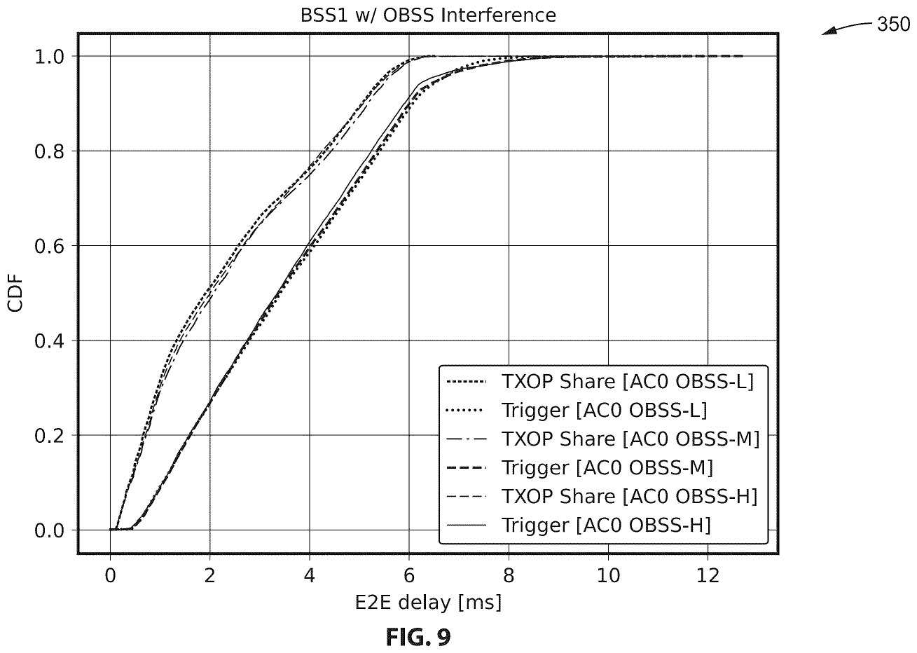

FIG. 9 depicts 350 the Cumulative Distribution Function (CDF) of the E2E delay of the non-AP STAs in BSS1 for both the trigger-based and the sharing-based protocol with different interference levels from the OBSS. This figure highlights that non-AP STAs in BSS1 experience lower E2E delays when the sharing-based protocol is used compared to the trigger-based protocol, which is due to the nature of the trigger-based protocol, which solicits UL transmissions with a trigger frame, and thus, reduces channel access flexibility from the perspective of the non-AP STAs.

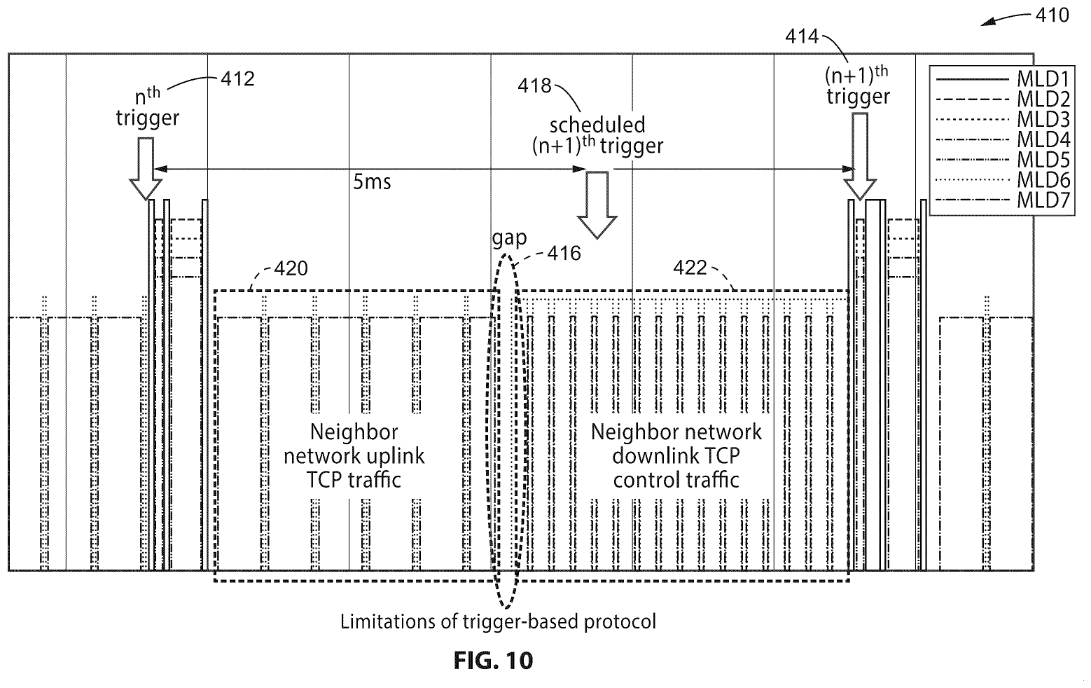

FIG. 10 illustrates 410 operational limitations of a trigger-based protocol showing representative frame transmissions between two consecutive trigger frames. An n^{th} trigger 412 is seen followed by neighbor UL TCP traffic 420, after which is seen a gap 416, prior to neighbor DL TCP control traffic 422.

The figure illustrates the presence of a short time gap 416 in which the medium is free from traffic, between two TXOPs held by the OBSS AP or non-AP STAs. A TXOP for the OBSS UL Transmission Control Protocol (TCP) traffic 420, and a TXOP for the OBSS Downlink (DL) TCP traffic 422. The trigger frame from BSS1, denoted as n^{th} trigger 412, initiates a TXOP before the TXOP of the OBSS UL TCP traffic and before a subsequent trigger frame, denoted as (n+1)^{th} trigger 418. When the (n+1)^{th} trigger is generated, the channel is occupied by the TXOP of the OBSS DL TCP traffic, and thus the (n+1)^{th} trigger cannot be transmitted until after the OBSS completes its TXOP and AP1 is able to obtain channel access.

In this case, while a short time gap 416 exists between the TXOPs held by the OBSS which could have been utilized by the reference BSS to acquire the channel and initiate a new TXOP, the (n+1)^{th} trigger should be postponed, from its scheduled time 418 to the actual time 414, resulting in additional queuing delays for the buffered packets in the non-AP STAs of the reference BSS. This is in contrast to what occurs with the EDCA-based, or the sharing-based protocol, where the non-AP STAs associated with the reference BSS can contend for the channel as needed, wherein no gap in medium utilization need arise.

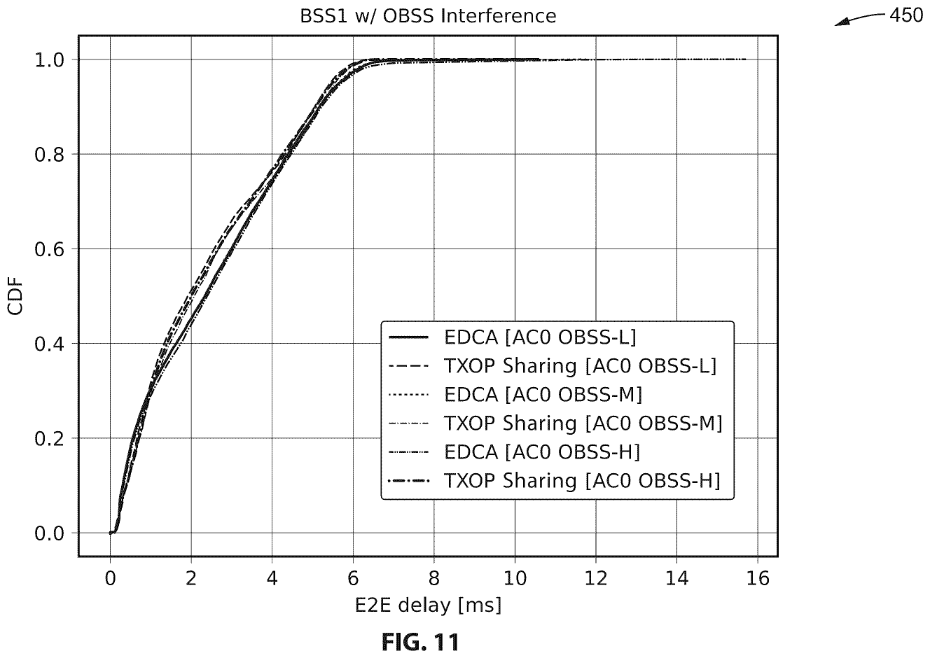

FIG. 11 illustrates 450 the CDF of the E2E delay for both the EDCA-based and sharing-based protocols using different interference levels from the OBSS. This figure highlights that non-AP STAs in BSS1 experience comparable E2E delays with slight improvement when the sharing-based protocol is used as compared with the EDCA-based protocol as both are able to contend for the channel aggressively while the sharing based protocol is able to help mitigate interferences across all the non-AP STAs.

5.2 OBSS with Same Priority Traffic

Another use case considered in the simulation campaign is to study the effects from an OBSS when this is operating with the same priority traffic as that of the reference BSS. In this case, both the reference BSS and the OBSS use AC3 for channel access, while the other assumptions are the same as that described in Section 5.1. It should be noted that in this case, as the OBSS has the same priority class than the reference BSS, then both the contention from the OBSS AP and non-AP STAs and the blockage caused by the existing transmission(s) from the OBSS have equal impact on the worse-case E2E delay of the non-AP STAs associated with the reference BSS.

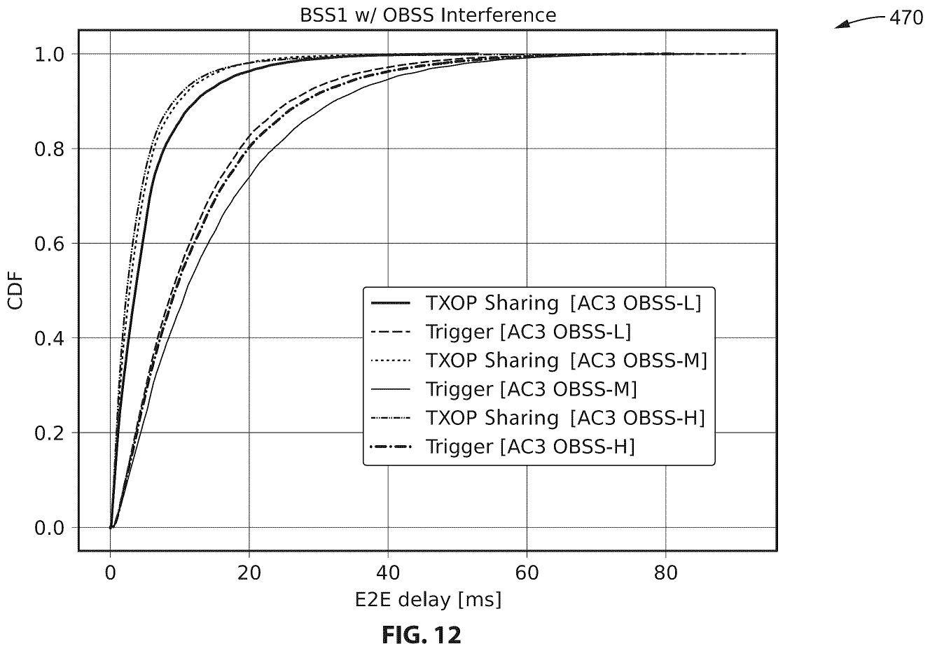

FIG. 12 illustrates 470 the CDF of the E2E delay of the non-AP STAs in BSS1 for both the trigger-based and sharing-based protocol with different interference levels. This figure highlights that the non-AP STAs associated with the reference BSS experience less E2E delay when the sharing-based protocol is used as compared with the trigger-based protocol. This improved performance is due to the higher flexibility that the sharing-based protocol is able to offer. Furthermore, this figure shows higher E2E delays than similar results in Section 5.1, which is due to the increased contention by using AC3 at the OBSS.

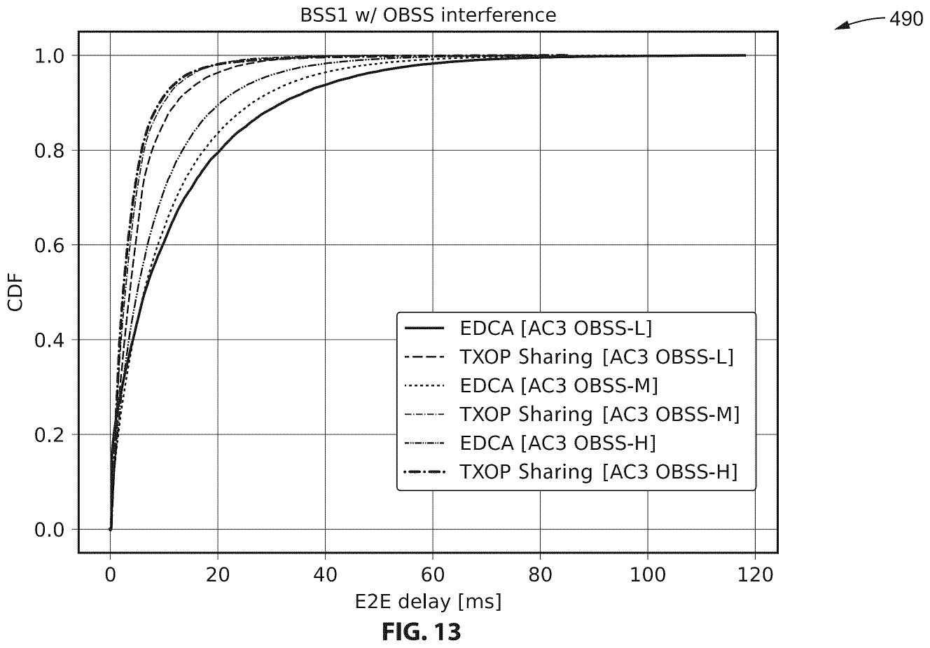

FIG. 13 illustrates 490 the CDF of the E2E delay of the non-AP STAs in BSS1 for both the EDCA-based and sharing-based protocol with different interference levels. This figure highlights that the non-AP STAs in BSS1 experiences less E2E delay when the sharing-based protocol is used instead of the EDCA-based protocol. While with both protocols, any time gap is more aggressively used to contend for the channel, and once again the sharing-based protocol offers an inherent advantage in reducing not only the intra-BSS contention but also the inter-BSS contention.

### 6. Conclusion

The present disclosure, toward coping with increasingly stringent requirements for next-generation WLAN systems, provides a new channel access procedure, which allows mitigating channel access contention in such systems by allowing cooperation among STAs while maintaining channel access flexibility for non-AP STAs that are provided by conventional channel access procedures, such as are currently adopted by the Wi-Fi 802.11 standard. This sharing-based protocol reviews two state-of-art protocols, i.e., EDCA-based and trigger based protocol, and uses a statistical model and closed form expressions to evaluate the probability of a successful channel access for the non-AP STAs within the coverage area of a reference BSS in presence of an OBSS for all three protocols. Furthermore, a comprehensive system level analysis of the three protocols is provided. Both analytical and system level analysis show that the disclosed protocol outperforms the two state-of-art protocols in terms of mitigating E2E delay and allowing for improved spectrum utilization by reducing overall system congestion.

### 7. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored locally to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A station apparatus for communication in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD), and wherein said STA operates as either an Access Point (AP) STA or a non-AP STA, for communicating with other STAs using a carrier sense multiple access/collision avoidance (CSMA/CA) mechanism; (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol which provides transmit opportunity (TXOP) sharing toward mitigating contention among non-AP STAs in a cooperative TXOP sharing process, comprising: (e)(i) initiating a TXOP by said STA operating as a non-AP STA, which is operating as the TXOP holder; (e)(ii) transmitting a frame from the TXOP holder to its access point (AP), wherein said frame indicates TXOP holder intention of sharing its TXOP with other stations; (e)(iii) wherein said non-AP STA operating as the TXOP holder coordinates with its AP, which then communicates this intention of sharing the TXOP, as well as sharing allocation information, to other non-AP STAs on the network for participating in sharing the TXOP; and (e)(iv) wherein in response to this coordination on sharing the TXOP of the TXOP holder, with other non-AP STAs on the network which are participating in the shared TXOP, data frames are transmitted over the channel by these shared TXOP participants according to the allocation information provided to them, and without having to contend for channel access.

A station apparatus for communication in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD), and wherein said STA operates as either an Access Point (AP) STA or a non-AP STA, for communicating with other STAs using a carrier sense multiple access/collision avoidance (CSMA/CA) mechanism; (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol which provides transmit opportunity (TXOP) sharing toward mitigating contention among non-AP STAs in a cooperative TXOP sharing process, comprising: (e)(i) initiating a TXOP by said STA operating as a non-AP STA, which is operating as the TXOP holder; (e)(ii) transmitting a frame from the TXOP holder to its access point (AP), wherein said frame indicates TXOP holder intentions of sharing its TXOP with other stations; (e)(iii) wherein said non-AP STA operating as the TXOP holder coordinates with its AP, which then communicates this intention of sharing the TXOP, as well as sharing allocation information, to other non-AP STAs on the network for participating in sharing the TXOP; (e)(iv) wherein in response to this coordination on sharing the TXOP of the TXOP holder, with other non-AP STAs on the network which are participating in the shared TXOP, data frames are transmitted over the channel by these shared TXOP participants according to the allocation information provided to them, and without having to contend for channel access; and (e)(v) wherein the intention of sharing the TXOP is communicated between the AP and the other non-AP STAs using information contained in a ready-to-send (RTS) sharing frame and a clear-to-send (CTS) sharing frame which are RTS and CTS frame which also carry TXOP sharing information.

A method for performing communication in a wireless network, comprising: (a) communicating between stations, wherein each said station (STA) is configured as a separate STA or as a STA within a multiple-link device (MLD), and wherein said STA operates as either an Access Point (AP) STA or a non-AP STA, for communicating with other STAs using a carrier sense multiple access/collision avoidance (CSMA/CA) mechanism for wirelessly communicating with other STAs on a IEEE 802.11 wireless local area network (WLAN); and (b) performing steps of a wireless communications protocol which provides transmit opportunity (TXOP) sharing toward mitigating contention among non-AP STAs in a cooperative TXOP sharing process, comprising: (b)(i) initiating a TXOP by said STA operating as a non-AP STA, which is operating as the TXOP holder; (b)(ii) transmitting a frame from the TXOP holder to its access point (AP), wherein said frame indicates TXOP holder intentions of sharing its TXOP with other stations; (b)(iii) wherein said non-AP STA operating as the TXOP holder coordinates with its AP, which then communicates this intention of sharing the TXOP, as well as sharing allocation information, to other non-AP STAs on the network for participating in sharing the TXOP; and (b)(iv) wherein in response to this coordination on sharing the TXOP of the TXOP holder, with other non-AP STAs on the network which are participating in the shared TXOP, data frames are transmitted over the channel by these shared TXOP participants according to the allocation information provided to them, and without having to contend for channel access.

The apparatus or method of any preceding implementation, wherein said protocol is directed towards reducing contention among non-AP STAS, while maintaining the ability of non-AP STAs to independently contend for channel access.

The apparatus or method of any preceding implementation, wherein said frame, which indicates that the TXOP holder intends to share its TXOP with other stations, further contains information on traffic priority requirements.

The apparatus or method of any preceding implementation, wherein said frame containing TXOP holder intention of sharing its TXOP with other non-AP STAs comprises a ready-to-send (RTS) frame containing the sharing allocations and/or traffic priority requirements

The apparatus or method of any preceding implementation, wherein any of the other non-AP STAs receiving the intention of sharing the TXOP can communicate back to their AP that they will not be using the shared TXOP.

The apparatus or method of any preceding implementation, wherein the intention of sharing the TXOP is communicated between the AP and the other non-AP STAs using information contained in a ready-to-send (RTS) sharing frame and a clear-to-send (CTS) sharing frame which are RTS and CTS frames which also carry TXOP sharing information.

The apparatus or method of any preceding implementation, wherein when said STA as TXOP holder has completed sharing its TXOP, then the AP of the TXOP holder clears the network allocation vector (NAV), which prevented channel contentions during the shared TXOP.

The apparatus or method of any preceding implementation, wherein said protocol is directed towards reducing contention among non-AP STAS, while maintaining the ability of non-AP STAs to independently contend for channel access.

The apparatus or method of any preceding implementation, wherein said frame, which indicates that the TXOP holder intends to share its TXOP with other stations, further contains information on traffic priority requirements.

The apparatus or method of any preceding implementation, wherein said frame containing TXOP holder intentions of sharing its TXOP with other non-AP STAs comprises a ready-to-send (RTS) frame containing the sharing allocations and/or traffic priority requirements

The apparatus or method of any preceding implementation, wherein any of the other non-AP STAs receiving the intention of sharing the TXOP can communicate back to their AP that they will not be using the shared TXOP.

The apparatus or method of any preceding implementation, wherein the intention of sharing the TXOP is communicated between the AP and the other non-AP STAs using information contained in a ready-to-send (RTS) sharing frame and a clear-to-send (CTS) sharing frame which are RTS and CTS frames which also carry TXOP sharing information.

The apparatus or method of any preceding implementation, wherein when said STA as TXOP holder has completed sharing its TXOP, then the AP of the TXOP holder clears the network allocation vector (NAV), which prevents channel contentions during the shared TXOP.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
Main Simulation Parameters

| Parameters | Values | |
|---|---|---|
| Carrier Frequency | 5 | GHz |
| Bandwidth | 80 | MHz |
| Maximum TXOP | 5 | ms |
| AP transmission power | 21 | dBm |
| STA transmission power | 15 | dBm |
| MCS | 64 QAM w/3/4 code rate | |
| Payload size | 1400 | bytes |

What is claimed is:

1. A station apparatus for communication in a wireless network, the apparatus comprising:
(a) at least one modem coupled to at least one radio-frequency (RF) circuit, with each RF circuit connected to one or multiple antennas;
(b) wherein said station (STA) is configured as a separate STA or as a STA within a multiple-link device (MLD), and wherein said STA operates as either an Access Point (AP) STA or a non-AP STA, for communicating with other STAs using a carrier sense multiple access/collision avoidance (CSMA/CA) mechanism;
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol which provides transmit opportunity (TXOP) sharing toward mitigating contention among non-AP STAs in a cooperative TXOP sharing process, comprising:
(i) initiating a TXOP by said STA operating as a non-AP STA, which is operating as the TXOP holder;
(ii) transmitting a frame from the TXOP holder to its access point (AP), wherein said frame indicates TXOP holder intention of sharing its TXOP with other stations;
(iii) wherein said non-AP STA operating as the TXOP holder coordinates with its AP, which then communicates this intention of sharing the TXOP, as well as sharing allocation information, to other non-AP STAs on the network for participating in sharing the TXOP; and
(iv) wherein in response to this coordination on sharing the TXOP of the TXOP holder, with other non-AP STAs on the network which are participating in the shared TXOP, data frames are transmitted over the channel by these shared TXOP participants according to the allocation information provided to them, and without having to contend for channel access.

2. The apparatus of claim 1, wherein said protocol is directed towards reducing contention among non-AP STAs, while maintaining the ability of non-AP STAs to independently contend for channel access.

3. The apparatus of claim 1, wherein said frame, which indicates that the TXOP holder intends to share its TXOP with other stations, further contains information on traffic priority requirements.

4. The apparatus of claim 3, wherein said frame containing TXOP holder intention of sharing its TXOP with other non-AP STAs comprises a ready-to-send (RTS) frame containing the sharing allocations and/or traffic priority requirements.

5. The apparatus of claim 4, wherein any of the other non-AP STAs receiving the intention of sharing the TXOP can communicate back to their AP that they will not be using the shared TXOP.

6. The apparatus of claim 1, wherein the intention of sharing the TXOP is communicated between the AP and the other non-AP STAs using information contained in a ready-to-send (RTS) sharing frame and a clear-to-send (CTS) sharing frame which are RTS and CTS frames which also carry TXOP sharing information.

7. The apparatus of claim 1, wherein when said STA as TXOP holder has completed sharing its TXOP, then the AP of the TXOP holder clears the network allocation vector (NAV), which prevented channel contentions during the shared TXOP.

8. A station apparatus for communication in a wireless network, the apparatus comprising:
(a) at least one modem coupled to at least one radio-frequency (RF) circuit, with each RF circuit connected to one or multiple antennas;
(b) wherein said station (STA) is configured as a separate STA or as a STA within a multiple-link device (MLD), and wherein said STA operates as either an Access Point (AP) STA or a non-AP STA, for communicating with other STAs using a carrier sense multiple access/collision avoidance (CSMA/CA) mechanism;
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol which provides transmit opportunity (TXOP) sharing toward mitigating contention among non-AP STAs in a cooperative TXOP sharing process, comprising:
(i) initiating a TXOP by said STA operating as a non-AP STA, which is operating as the TXOP holder;
(ii) transmitting a frame from the TXOP holder to its access point (AP), wherein said frame indicates TXOP holder intentions of sharing its TXOP with other stations;
(iii) wherein said non-AP STA operating as the TXOP holder coordinates with its AP, which then communicates this intention of sharing the TXOP, as well as sharing allocation information, to other non-AP STAs on the network for participating in sharing the TXOP;
(iv) wherein in response to this coordination on sharing the TXOP of the TXOP holder, with other non-AP STAs on the network which are participating in the shared TXOP, data frames are transmitted over the channel by these shared TXOP participants according to the allocation information provided to them, and without having to contend for channel access; and
(v) wherein the intention of sharing the TXOP is communicated between the AP and the other non-AP STAs using information contained in a ready-to-send (RTS) sharing frame and a clear-to-send (CTS) sharing frame which are RTS and CTS frame which also carry TXOP sharing information.

9. The apparatus of claim 8, wherein said protocol is directed towards reducing contention among non-AP STAs, while maintaining the ability of non-AP STAs to independently contend for channel access.

10. The apparatus of claim 8, wherein said frame, which indicates that the TXOP holder intends to share its TXOP with other stations comprises information on traffic priority requirements.

11. The apparatus of claim 8, wherein any of the other non-AP STAs receiving the intention of sharing the TXOP can communicate back to their AP that they will not be using the shared TXOP.

12. The apparatus of claim 8, wherein when said STA as TXOP holder has completed sharing its TXOP, then the AP of the TXOP holder clears the network allocation vector (NAV), which prevented channel contentions during the shared TXOP.

13. A method for performing communication in a wireless network, comprising:
(a) communicating between stations, wherein each said station (STA) is configured as a separate STA or as a STA within a multiple-link device (MLD), and wherein said STA operates as either an Access Point (AP) STA or a non-AP STA, for communicating with other STAs using a carrier sense multiple access/collision avoidance (CSMA/CA) mechanism for wirelessly communicating with other STAs on a IEEE 802.11 wireless local area network (WLAN); and
(b) performing steps of a wireless communications protocol which provides transmit opportunity (TXOP) sharing toward mitigating contention among non-AP STAs in a cooperative TXOP sharing process, comprising:
(i) initiating a TXOP by said STA operating as a non-AP STA, which is operating as the TXOP holder;
(ii) transmitting a frame from the TXOP holder to its access point (AP), wherein said frame indicates TXOP holder intentions of sharing its TXOP with other stations;
(iii) wherein said non-AP STA operating as the TXOP holder coordinates with its AP, which then communicates this intention of sharing the TXOP, as well as sharing allocation information, to other non-AP STAs on the network for participating in sharing the TXOP; and
(iv) wherein in response to this coordination on sharing the TXOP of the TXOP holder, with other non-AP STAs on the network which are participating in the shared TXOP, data frames are transmitted over the channel by these shared TXOP participants according to the allocation information provided to them, and without having to contend for channel access.

14. The method of claim 13, wherein said protocol is directed towards reducing contention among non-AP STAs, while maintaining the ability of non-AP STAs to independently contend for channel access.

15. The method of claim 13, wherein said frame, which indicates that the TXOP holder intends to share its TXOP with other stations, further contains information on traffic priority requirements.

16. The method of claim 15, wherein said frame containing TXOP holder intentions of sharing its TXOP with other non-AP STAs comprises a ready-to-send (RTS) frame containing the sharing allocations and/or traffic priority requirements.

17. The method of claim 15, wherein any of the other non-AP STAs receiving the intention of sharing the TXOP can communicate back to their AP that they will not be using the shared TXOP.

18. The method of claim 13, wherein the intention of sharing the TXOP is communicated between the AP and the other non-AP STAs using information contained in a ready-to-send (RTS) sharing frame and a clear-to-send (CTS) sharing frame which are RTS and CTS frames which also carry TXOP sharing information.

19. The method of claim 13, wherein when said STA as TXOP holder has completed sharing its TXOP, then the AP of the TXOP holder clears the network allocation vector (NAV), which prevented channel contentions during the shared TXOP.
